(19) United States
(12) Patent Application Publication
(10) Pub. No.: US 2008/0156838 A1
(43) Pub. Date: Jul. 3, 2008

(54) Wheelchair basket

(76) Inventor: Stacey Johnson, Capreol (CA)

Correspondence Address: MIKE M. GAUTHIER, 190 CHURCH STREET, BOX 400, GARSON, ON, P3L 1V7, omitted

(21) Appl. No.: 11/646,510

(22) Filed: Dec. 28, 2006

(51) Int. Cl. B60R 7/00; B60R 9/00

(52) U.S. Cl. 224/407

(57) ABSTRACT

An accessory basket for attachment to a wheelchair comprising: a sturdy basket, a pivotal extending rail, wheelchair connecting means, and a catch mechanism. Two wheelchair-connecting members are provided; one having a hinge pivot assembly and the other a catch mechanism. The outer telescopic rail is adapted with a strike, mating with a catch adapted to the wheelchair-connecting member, while the inner telescopic rail is adapted with an upper hinge portion mating with a lower hinge portion adapted to an opposing wheelchair-connecting member. A catch release disengages the strike to allow the rail and basket assembly to be rotated on a vertical axis toward the side of said wheelchair, and the basket can thus be extended toward the front of said chair, making access to said basket easy and convenient.

### FIELD OF THE INVENTION

The present invention relates to an accessory basket for attachment to a wheelchair. The invention comprises: a sturdy basket, a pivotal extending rail, wheelchair connecting means, and a catch mechanism. Two wheelchair-connecting members are provided; one having a hinge pivot assembly and the other a catch mechanism. The outer telescopic rail is adapted with a strike, mating with a catch adapted to the wheelchair-connecting member, while the inner telescopic rail is adapted with an upper hinge portion mating with a lower hinge portion adapted to an opposing wheelchair-connecting member. A catch release disengages the strike to allow the rail and basket assembly to be rotated on a vertical axis toward the side of said wheelchair, and the basket can thus be extended toward the front of said chair, making access to said basket easy and convenient.

### BACKGROUND OF THE INVENTION

While wheelchair storage devices have been part of prior art for some many years, there remains the ever-popular issue of accessibility to said storage devices. Many wheelchair users find it difficult to reach back to retrieve contents from the storage device.

Accordingly, it is desirable for those using wheelchairs to have easy access to belongings stored in his or her chair. The present inventor sought to provide those using wheelchairs with a removable, rotatable and extendable storage basket, which mounts to the rear of virtually any wheelchair.

Furthermore, many persons with mild handicaps alternate the use of a walker and a wheelchair. For example, a handicap driver, having a walker may choose to borrow a wheelchair in a shopping mall, but what to do with the walker has been a challenge as well. The present invention solves this problem by ensuring the basket of the present invention is fabricated of sturdy and durable material, sufficient to handle loads imposed by such walkers.

The applicant is aware of several attempts in prior art to provide wheelchair storage devices.

For example, reference may be had to the following U.S. Patents;
U.S. Pat. No. 4,795,182 of Dyess, issued Jan. 3, 1989,
U.S. Pat. No. 4,919,443 of Kehler, issued Apr. 24, 1990, and
U.S. Pat. No. 5,180,181 of Letechipia, issued Jan. 19, 1993

Conclusively, while many prior art inventions have succeeded in providing users of wheelchairs with accessory storage devices, none thus far have successfully combined the features of accessibility, sturdiness, ease of use and adaptability to various wheelchair models.

### SUMMARY OF THE INVENTION

It is thus the object of the present invention to provide wheelchair users with an accessible, sturdy, ease of use storage device that is also adaptable to virtually any electric wheelchair model.

In one aspect of the invention, there is provided a universal adapter to fixedly attach the wheelchair basket of the present invention to virtually any electric wheelchair.

In another aspect of the invention, the basket dimensions may vary dependant on user preference.

In yet another aspect of the invention, the strike and catch methods may be substituted with any equally suitable means.

Accordingly, the wheelchair basket of the present invention provides wheelchair users with a storage device incorporating the features of accessibility, sturdiness, ease of use and adaptability to various wheelchair models.

The utility of this accessory device includes but is not limited to electric wheelchairs.

### BRIEF DESCRIPTION OF THE DRAWINGS

These and other advantages of the invention will become apparent upon reading the following detailed description and upon referring to the drawings in which:

FIG. 1 is a partial front perspective view from above of the wheelchair basket of the present invention installed onto a conventional electric wheelchair.

FIG. 2 is a top plan view of the wheelchair basket of the present invention illustrating its pivotal and extension range.

FIG. 3 is rear perspective view from above of the wheelchair basket of the present invention.

FIG. 4 is a right side elevation view of the wheelchair basket of the present invention

FIG. 5a is a partial right side elevation view of latch mechanism of the wheelchair basket of the present invention illustrated the approach of the strike to the catch.

FIG. 5b is a partial right side elevation view of latch mechanism of the wheelchair basket of the present invention in a near catch position.

FIG. 5c is a partial right side elevation view of latch mechanism of the wheelchair basket of the present invention in a locked position.

FIG. 6 is an elevation view of the hinge portion of the wheelchair basket of the present invention.

FIG. 7 is a rear elevation view of the wheelchair basket of the present invention in its collapsed configuration.

FIG. 8 is a rear elevation view of the wheelchair basket of the present invention illustrating in its extended configuration.

FIG. 9a is a cross-section view taken along the lines 10-10 of FIG. 1 of the wheelchair basket of the present invention illustrating the rail assembly in a collapsed state.

FIG. 9b is a cross-section view taken along the lines 10-10 of FIG. 1 of the wheelchair basket of the present invention illustrating the rail assembly in an extended state.

While the invention will be described in conjunction with preferred illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE PREFERRED EMBODIMENT

In the following description, similar features in the drawings have been given similar reference numerals.

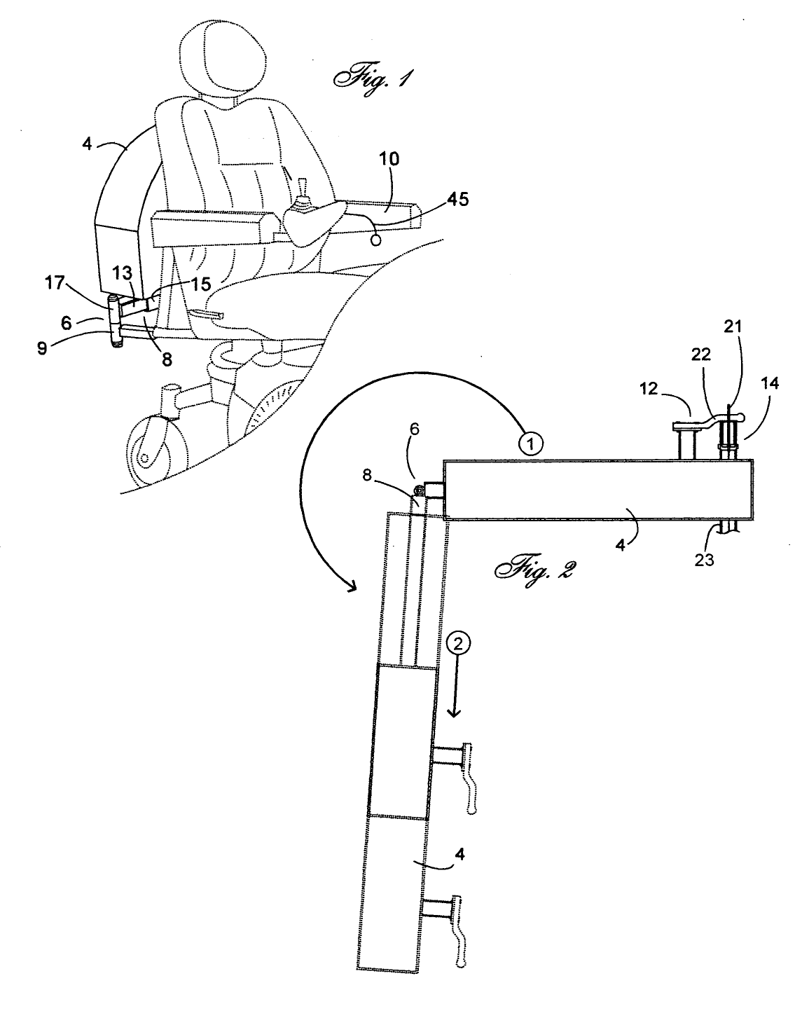

Turning to FIG. 1, which illustrates the arrangement of the wheelchair basket of the present invention onto a conventional electric wheelchair 10 wherein, universal wheelchair-attaching members, one, a male pivot member 9 and the second, a latch member are fixedly attached to the wheelchair's rear framework. A telescopic rail assembly 8 having an inner square tube 13 integrally attached to a female pivot member 17, and a square outer tube 15 having inner dimensions only slightly greater than the outer dimensions of the mating inner tube 13. Said outer tube 15 in securedly attached to the under side of the basket 4. The basket 4 and rail assembly 8 can thereby be pivoted toward the side of the wheelchair 10, and extended more closely toward the person occupying said wheelchair 10.

Turning now to FIG. 2, a top plan view of the wheelchair basket of the present invention illustrating said pivotal motion granted to the basket 4 and rail 8 assemblies along a vertical axis at the pivot assembly 6. Furthermore, this figure also depicts the extension capability also granted through the use of the telescopic rail assembly 8 thereby making it possible for the user to gain easy and convenient access to the basket's 4 content. A gravitational catch 21 in alignment with a strike 22 also easy the replacement of said basket 4 to its original rear-facing position. A catch release cord 23 is attached to the upper portion of said catch 21 thereby allowing remote disengagement of the basket 4 from said catch 21.

FIG. 3, a rear perspective view from above of the wheelchair basket of the present invention illustrates in clearer form, the full arrangement of the invention wherein; two wheelchair-attaching members 30 and 31, the first wheelchair-attaching member 30, incorporates a male pivot member 9 fixedly attached thereto, and the second wheelchair-attaching member 31, incorporates a latch assembly 12, which is located at the rearmost extreme of the second wheelchair-attaching member 31. A telescopic rail assembly 8 having an inner square tube 13 integrally attached to a female pivot member 17, and a square outer tube 15 having inner dimensions only slightly greater than the outer dimensions of the mating inner tube 13 thus both inner and outer tubes 13 and 15 are free to limitedly slide longitudinally along each other. Said outer tube 15 in securedly attached to the under side of the basket 4 therefore pulling the basket away from the pivot portion 6 will evidently bring along the outer tube 15. A strike assembly 12 having a strike extension 40 fixedly attached to the lower surface of the outer rail 15 distal to the pivot portion 6, a strike mount 41 also fixedly attached to the rearmost end of said strike extension 40. To place the basket 4 back in its original position, adjacent to the rear surface of the wheelchair's seat back, the user simply rotates the basket assembly toward the rear of the chair and the strike 22 will engage with the catch 21. To release said basket assembly, the user pulls the release cord 45. By disposing the wheelchair-attaching members 30 and 31 slightly downwardly and rearwardly, the basket 4 will have a gravitational tendency to displace from the catch 21.

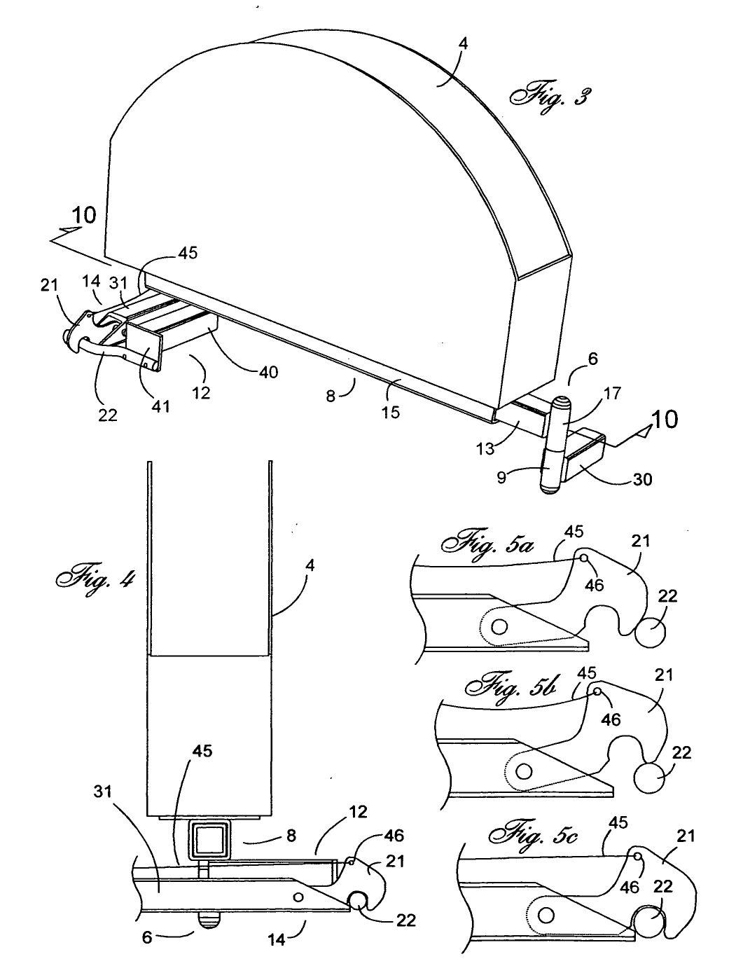

Turning now to FIG. 4, a right side elevation view of the wheelchair basket wherein the basket is shaped having two equal front and back planar sheet member shaped with an arch that substantially raises the effective height of the basket and, each side of said front and back members is generally equal in height to that of the basket's left and right side members thereby allow the benefit of placing larger articles in said basket 4 yet gaining easier access to same basket 4. Accordingly, a cover can be provided to selectively shelter the basket's contents from the elements. Again in this figure, the catch 5 assembly 12 is more closely depicted, illustrating the arrangement of the catch 21 within the wheelchair-attaching member 31 using a pin through said wheelchair-attaching member 31 providing a pivotal point for the catch 21. A release cord 45—attached to an eyelet 46 traversing the upper portion of the catch 21—allows the user to remotely disengage the catch to release the strike 22 thus freeing the basket 4.

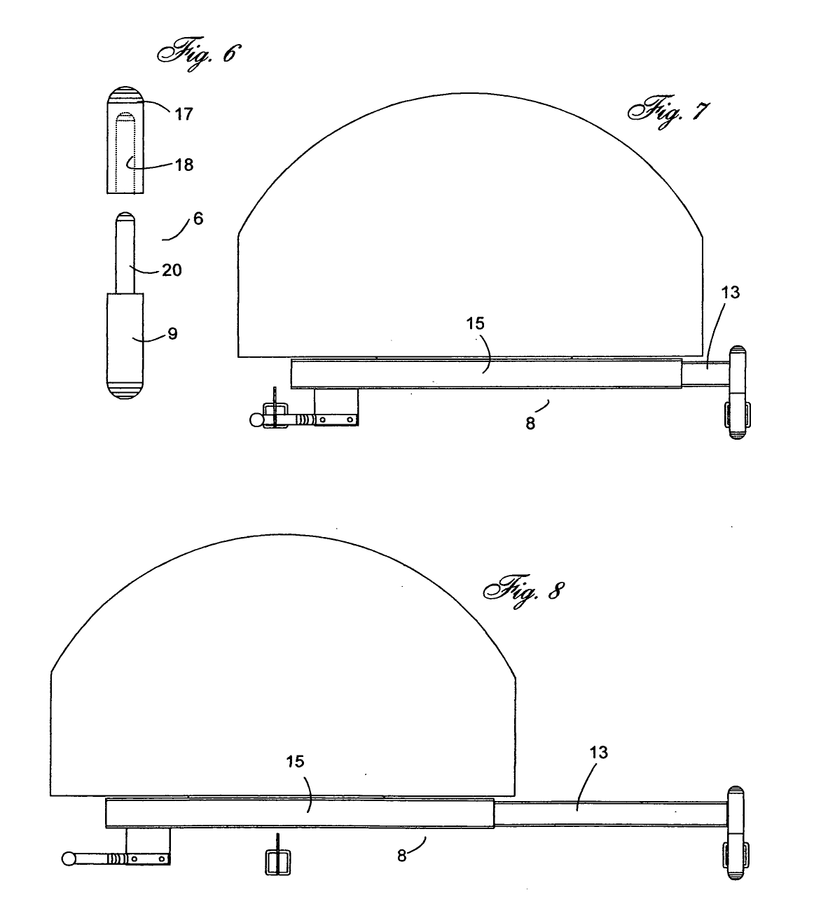

FIGS. 5a, 5b and 5c quite simply illustrate the mechanical interactivity between the catch 21 and the strike 22 as these parts approach to engage. The release cord 45 is attached to an eyelet 46 traversing the upper portion of the catch 21 and extends to the armrest portion of the wheelchair allowing the user to remotely disengage the catch to release the strike 22.

FIG. 6 is an elevation view of the pivot assembly 6 comprising: a lower male pivot member 9 having a slimmer stem 20, and an upper female pivot member 17 having a void 18 similar in geometry and tolerance to that of the lower pivot's 9 protruding stem 20. When engaged, these members 9 and 17 rotate along a vertical axis effectively causing a hinging motion.

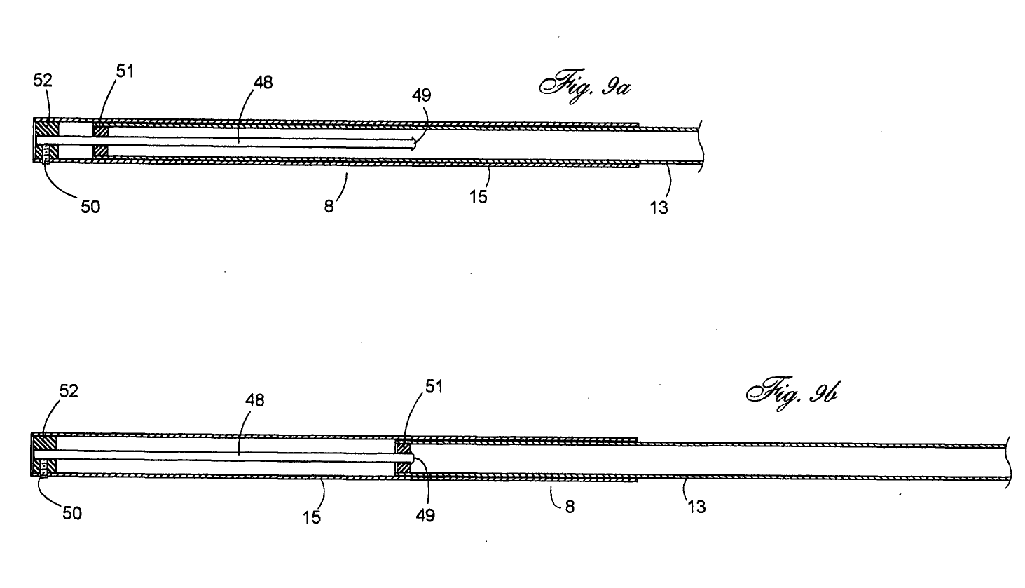

FIGS. 7 and 8 depict the position status of the various portions when collapsed (FIG. 7) and when extended (FIG. 8). An extension limiter is incorporated within the inner and outer tubes 13 and 15 of the rail assembly 8 for added safety.

Turning now to FIGS. 9a and 9b, both cross sections taken along lines 10-10 of FIG. 1 wherein the extension limiter system is further depicted. The inner tube 13 is adapted with a fixedly attached perforated insert 51 through which a limit rod 48 slidably traverses. Said limit rod 48 having a stop end 49 with an outer diameter greater that the inner diameter of the perforation of the inner tube's 13 insert 51 thus preventing the stop end 49 from traversing through said insert 51. The outer tube 15 is also adapted with a secondary perforated insert 52 frictionally engaged within the outer tube's 15 end distal to the pivot portion. However, the secondary insert 52 is threadedly bored through one side, and the outer tube 15 is bored in alignment with the insert 52 bore thereby providing access for a set screw 50 to lock the limit rod 48 securely within the bore of the outer tube's 15 secondary insert 52. Therefore, the inner tube 13 can travel longitudinally within the outer tube 15 to a limit generally equal to the free length of the limit rod 48.

Therefore, it is now possible, through the implementation of the wheelchair basket of the present invention, to provide those using wheelchairs to have a storage device that is all of; easily removable, adaptable to virtually any electric wheelchair, easy accessible, extendable, convenient and easy to deploy and retract.

1. A wheelchair basket comprising:
i. a wheelchair-connecting member having:
i. primary and secondary universal inserts, which adapt to various wheelchair models,
ii. a primary end fixedly attached to a primary universal insert-receiving member and having a hinge pivot distal to said primary insert-receiving member, and
iii. a secondary end fixedly attached to a secondary universal insert-receiving member and having a catch assembly distal to said secondary insert-receiving member,
ii. a telescopic tube assembly having:
i. an outer tube,
ii. an inner tube having outer dimensions slightly lesser than the inner dimensions of the outer tuber,
iii. extension limiting means,
iv. a hinge pivot fixedly attached to the exposed end of the inner tube, and
v. a basket mount fixedly attached to a top central area of the outer tube,
iii. a catch and latch assembly having:
i. a catch fixedly attached to a secondary wheelchair-connecting member,
ii. a latch fixedly attached to an end of the outer tube distal to the hinge pivot portion and in mating alignment with the catch,
iv. a basket portion having:
i. a bottom, two sides, a front and a rear,
ii. one or more drain perforation, and
iii. a removable cover.

2. The wheelchair basket of claim 1 wherein, the primary universal insert is securedly and releasably attached to a primary universal insert-receiving member.

3. The wheelchair basket of claim 1 wherein, the secondary universal insert is securedly and releasably attached to a secondary universal insert-receiving member.

4. The wheelchair basket of claim 1 wherein, the primary and secondary universal inserts are adapted with wheelchair mating members adapted to each mount on a vertical member.

5. The wheelchair basket of claim 1 wherein, the primary and secondary universal inserts are adapted with wheelchair mating members adapted to each mount on a rearward horizontal member.

6. The wheelchair basket of claim 1 wherein, the telescopic tube assembly comprising an outer tube, and an inner tube having outer dimensions slightly lesser than the inner dimensions of the outer tuber thus allowing longitudinal motion therebetween.

7. The wheelchair basket of claim 1 wherein, the telescopic tube assembly further comprises an extension limiter having:
i. an outer tube insert stop engaged within the outer tube end distal to the hinge pivot,
ii. an inner tube insert stop fixedly attached to the inner end of said inner tube distal to the hinge pivot.
iii. an inner limit rod with a capped end and a free end traversing first through a perforation within the center of the inner tube insert stop, then through a perforation within the center of the outer tube insert stop,
iv. a set screw traversing both the end of the outer tube distal to the hinge pivot and threadedly engages through one side of said outer tube insert stop also distal to the hinge pivot, thus immobilizing the extension limiter's longitudinal motion.

8. The wheelchair basket of claim 1 wherein, a rigid planar sheet material—of substantially smaller dimensions than those of the baskets bottom portion—is fixedly attached to the upper surface of the outer tube so as to provide means of securely fastening the basket to said outer tube.

9. The wheelchair basket of claim 1 wherein, a releasable catch is mounted to the secondary wheelchair-connecting member.

10. The wheelchair basket of claim 1 further comprising a release cord remotely attached to said catch and extending to the general seat area of said wheelchair thus allowing user to disengage said catch upon desire to do so.

11. The wheelchair basket of claim 1 further comprising a latch fixedly attached to the outer distal to the hinge pivot.

12. The wheelchair basket of claim 1 wherein, the latch is in mating alignment with the catch.

13. The wheelchair basket of claim 1 wherein the basket's long front and rear portions are substantially higher than the sides so as to ease access from the side while providing greater storage capacity and ability within said basket.
